(19) United States
(12) Patent Application Publication
(10) Pub. No.: US 2017/0148423 A1
(43) Pub. Date: May 25, 2017

(54) Methods for Stringed Instrument Construction

(71) Applicant: Randall Frank Muse, Lynnwood, WA (US)

(72) Inventor: Randall Frank Muse, Lynnwood, WA (US)

(21) Appl. No.: 14/952,622

(22) Filed: Nov. 25, 2015

(51) Int. Cl. G10D 3/06; G10D 3/12; G10D 3/04; G10D 3/14

(52) U.S. Cl. CPC G10D 3/06; G10D 3/14; G10D 3/12; G10D 3/04

(57) ABSTRACT

The Invention is designed so that it is comfortable to hold, and easy to play for long periods of time without becoming fatigued. There are two different designs that the invention can utilize. Both designs provide for an instrument that is compact, making it comfortable for the musician to reach various parts of the fingerboard while still providing a normal scale fretboard. The first design features one neck, shaped to look like the letter Z. The neck is actually composed of three sections: The first section contains the lower notes of the fretboard, while the second section contains the higher notes. Between these two sections sits a connecting strut that connects the strings via an additional string saddle. This design thus produces uses two separate fretboard areas that are easy to reach, providing comfortable access to a full scale of notes.

The second design includes two wholly separate necks, similar to a double neck guitar. (1) One neck is normal length and is meant to be used to play the higher notes of the scale. The musician has the option to play the lower notes on this neck, as well. To make the lower notes easier to reach, another neck is included just below the first neck. The second neck is either placed further up the body horizontally, or is undersized, making the lower frets closer to the body of the musician. The second neck's bridge is located on the back of the instrument, thus providing a regular string length, and thus a full scale of notes. This design is similar to that of portable guitars, but goes a step further. Instead of replacing the head stock of the instrument with a back mounted bridge, (2) or using a removable neck, (3) the placement of the neck is moved further up the body horizontally. Like some portable instruments, the bridge is mounted on the back side, but for different reasons. In the invention, the bridge is moved much further up the back of the instrument, allowing either the neck to be placed further up the body on the front side, or an undersized neck to be used, thus keeping a full scale of notes on the fretboard. The lower notes of this neck are easier to reach than a normal positioned neck. The higher notes of this neck will be hard to reach, but can be utilized by musicians for some applications, most notably slide playing, and harmonic effects. For others, the first neck will be used for playing on higher frets.

Additionally, both instrument designs utilize a curved underside, conforming to the shape of the leg, thus providing for comfortable sitting playing.

### CROSS-REFERENCE TO RELATED APPLICATIONS

This application claims the benefit of U.S. provisional application No. 62/084,296 filed Nov. 25, 2014.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### DESCRIPTION

Background of the Invention

Most stringed instruments are constructed such that the musician must extend the arm outward in order to reach higher frets of the fingerboard. This design causes the musician's arm and shoulder to quickly tire from having to reach outward. The design also affects the musician's wrist, causing it to stretch in various contortions in order to place the fingers on the lower frets of the fingerboard. In the long term the design can cause chronic soreness, arthritis, and tendon damage to the affected areas. Instrument makers have attempted to alleviate the problem by producing a shorter neck, resulting in a shorter scale instrument. Others have constructed portable instruments that include a removable neck, [3] move the headstock portion to the end of the body, [2] or move the headstock to the rear face of the instrument. [4] Others have produced double neck instruments with short necks providing a shorter scale fretboard. A shorter neck does make an instrument easier to play, but the shorter neck doesn't include the lower notes found on a regular size neck. Portable guitars do provide for a smaller and lighter instrument, but these instruments have full size necks, and thus have the same problem as regular guitars, with the lower notes of the fretboard being difficult to reach. Moreover, since portable instruments eliminate the head stock and a portion of the back end of the instrument, they do not have the full-body sound and tone of a normal size instrument. Therefore there exists a need for full scale stringed instruments with easy to reach fingerboards that which enable a musician to play without developing muscle soreness and chronic pain.

Field of the Invention

This invention is intended for the stringed instrument making industry, consisting of luthiers and firms that mass produce stringed instruments. The instruments in the field consist mainly of acoustic/electric guitars, sitars, bass guitars, violins, cellos, mandolins, ukuleles, and upright bass, though may include any type of stringed instrument.

### BRIEF SUMMARY OF THE INVENTION

The Invention is designed so that it is comfortable to hold and easy to play for long periods of time without becoming fatigued. The invention allows the musician to easily reach all parts of the fingerboard with an instrument with a regular scale length.

The invention utilizes two necks in a style that appears similar to a double neck guitar. [1] The top neck is normal length and is meant to be used to play the higher notes of the scale, which are naturally easy to reach, being closer to the musician's body. The musician has the option to play the lower notes on this neck as well. To make the lower notes easier to reach, another, shorter neck is located just below the top neck. In one variation of the invention the bottom neck is one half the size of a regular neck, while in another variation the bottom neck is placed further up the body horizontally, and is either regular length or three quarters length. In both cases the neck serves to make the lower frets closer to the body of the musician.

### SUMMARY OF EMBODIMENTS THE INVENTION

The Invention is designed so that it is comfortable to hold and easy to play for long periods of time without becoming fatigued. The invention allows the musician to easily reach all parts of the fingerboard with an instrument with a regular scale length.

The invention utilizes two necks in a style that appears similar to a double neck guitar. [1] The top neck is normal length and is meant to be used to play the higher notes of the scale, which are naturally easy to reach, being closer to the musician's body. The musician has the option to play the lower notes on this neck as well. To make the lower notes easier to reach, another, shorter neck is located just below the top neck. In one variation of the invention the bottom neck is one half the size of a regular neck, while in another variation the bottom neck is placed further up the body horizontally, and is either regular length or three quarters length. In both cases the neck serves to make the lower frets closer to the body of the musician. The bottom neck's bridge location represents another variation. The bridge can be placed either at the end of the body's front face, on a strut that connects to the end of the instrument body, or on the rear face of the instrument. Since the bridge is pushed back farther from where it is normally found, the neck can be moved back as well. In doing so, the invention maintains a full scale length while providing easy to reach fingerboard positions on the lower half of the scale.

When the bridge is placed on the rear face of the instrument, the strings of the bottom neck wrap around the edge of the instrument body via a set of individual string rollers [4] that resemble small shirt buttons. The rollers allow the strings to glide freely over and around the edge of the instrument body without the friction of a string nut. The rollers revolve around a spindle, with a separate roller for each string. The rollers can contain a sealed, greased bearing, which have not been utilized to this point, and are useful for keeping the strings in tune. Rollers are preferably made of a hard material such as graphite or metal, but could be made of any material.

### BRIEF DESCRIPTION OF THE SEVERAL VIEWS OF THE DRAWING(S)

In FIG. 2, the bottom side (A) is curved to fit comfortably over the leg of the player. The top neck of the instrument (G) provides the highest notes of the fingerboard, is regular length, and positioned like a normal neck. It uses a string nut (F) and bridge. (E) The bottom neck (H) is one half normal length. When the bridge is located on the rear face of instrument the bottom neck uses string nut, (C) and a set of string rollers. (D) Just past string nut (C) are tuning pegs for each string.

FIG. 3 shows the back of the instrument for when the bridge is located on the rear face, with bridge (B) anchoring the strings.

In FIG. 4, the bottom side (A) is curved to fit comfortably over the leg of the player. The top neck of the instrument (G) provides the highest notes of the fingerboard, is regular length, and positioned like a normal neck. It uses a string nut (F) and bridge. (E) The bottom neck (H) is approximately ¾ normal length. When the bridge is located on the rear face of instrument the bottom neck uses string nut, (C) and a set of string rollers. (D) Just past string nut (C) are tuning pegs for each string.

In FIG. 5, the bottom side (A) is curved to fit comfortably over the leg of the player. The top neck of the instrument (G) provides the highest notes of the fingerboard, is regular length, and positioned like a normal neck. It uses a string nut (F) and bridge. (E) The bottom neck (H) is one half normal length, but could also be ¾ normal length. The bottom neck uses string nut, (C) which guide the strings down the neck where they are anchored by a bridge (B) that it attached to a strut extending out 4 to 7 inches from the edge of the instrument body. Just past string nut (C) are tuning pegs for each string.

### DETAILED DESCRIPTION OF THE INVENTION

This description is described to enable any person skilled in the art to make and use the invention, and is shown here with the knowledge that various changes to the disclosed embodiments will be apparent to those skilled in the art, and that these changes would not supersede the scope of the invention as depicted herein. Thus, the invention is not intended to be limited to the embodiments shown, but is to be given the widest scope parallel to the methods illustrated herein.

It should be understood that the invention can be used with an acoustic or electric guitar, sitar, bass guitar, ukulele, cello, upright bass, mandolin, violin, or any other type of stringed instrument.

In the invention the bridge can be placed on the rear face of the instrument. In this variation, the strings of the bottom neck wrap around the edge of the instrument body via a set of individual string rollers [4] that resemble small shirt buttons. The rollers allow the strings to glide freely over and around the edge of the instrument body without the friction of a string nut. The rollers revolve around a spindle, with a separate roller for each string. The rollers can contain a sealed, greased bearing, which have not been utilized to this point, and are useful for keeping the strings in tune. Rollers are preferably made of a hard material such as graphite or metal, but could be made of any material.

The invention utilizes two necks in a style that appears similar to a double neck guitar. [1] The top neck is normal length and is meant to be used to play the higher notes of the scale, which are naturally easy to reach, being closer to the musician's body. The musician has the option to play the lower notes on this neck as well. To make the lower notes easier to reach, another, shorter neck is included just below the top neck. The bottom neck is one half the size of a regular neck, serving to make the lower frets closer to the body of the musician. The bottom neck's bridge location is an important aspect of the invention. The bridge for the bottom neck can be placed either at the end of the body's front face, on a strut that connects to the end of the instrument body, or on the rear face of the instrument, thus providing for a full scale length. Additionally, the neck placement can be altered by putting the short neck on top, with the long neck underneath.

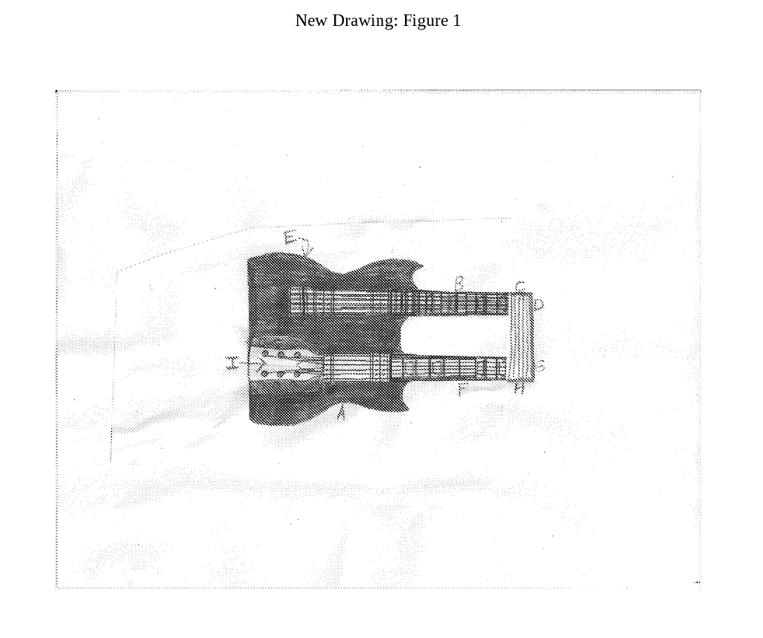

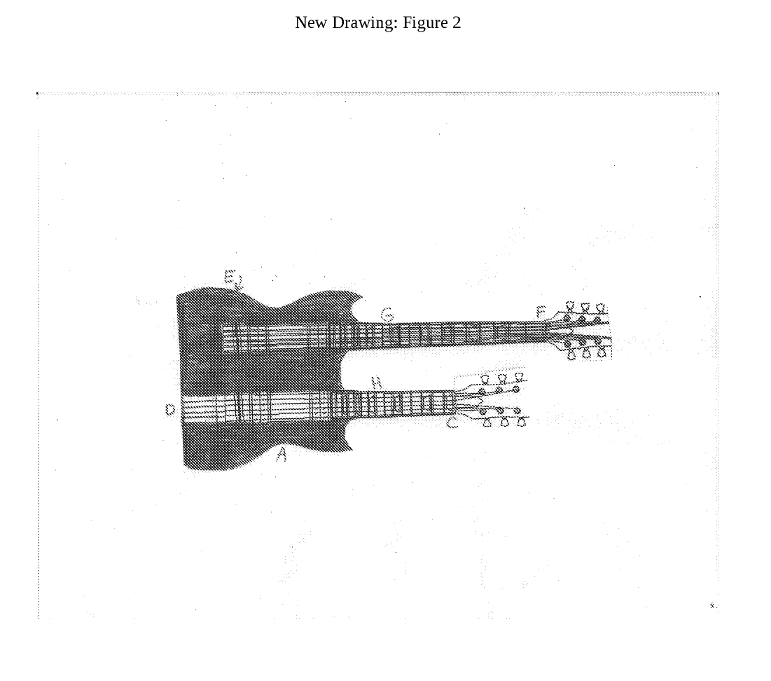

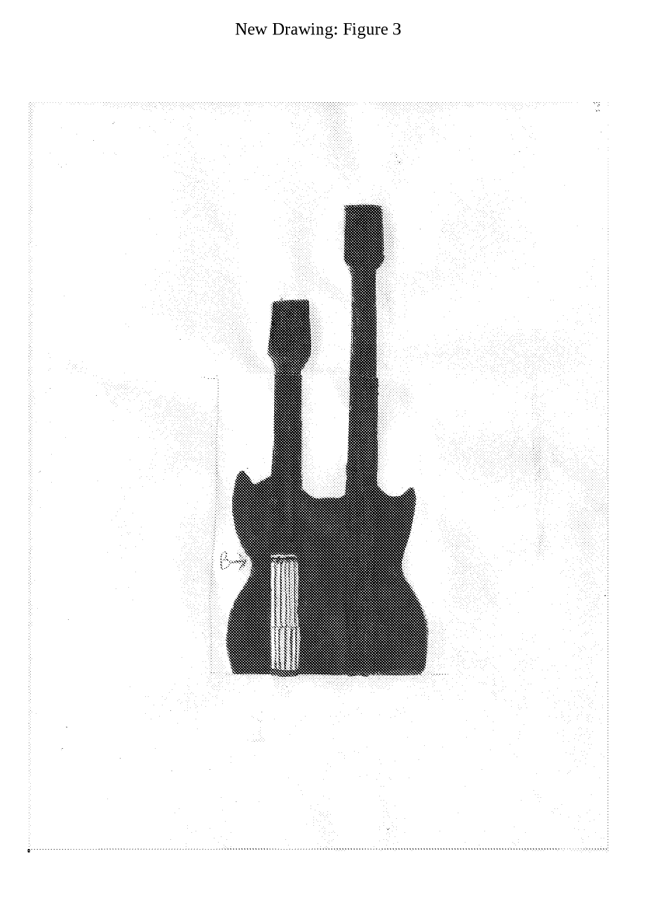

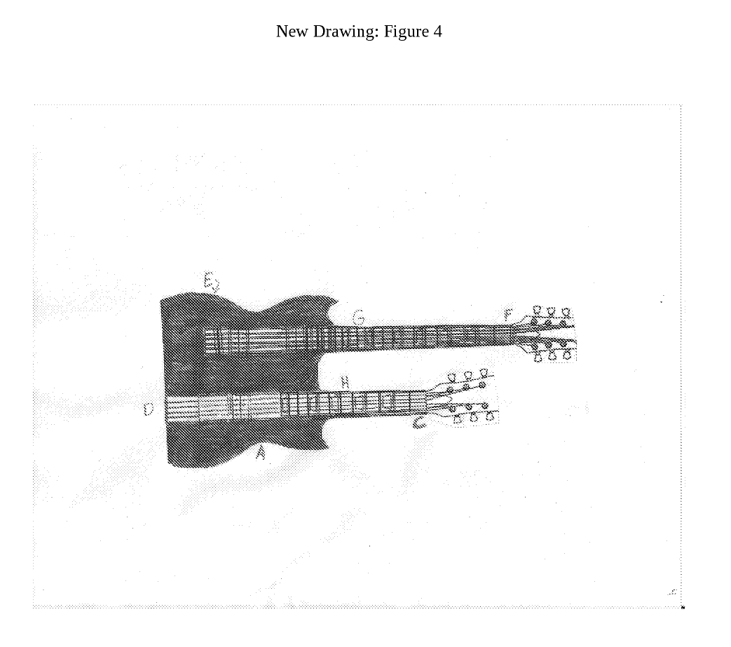

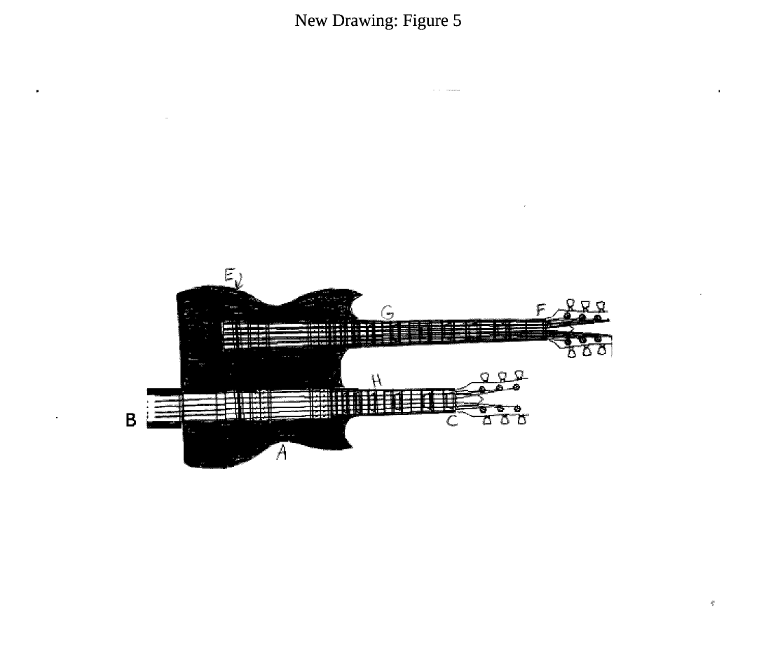

In FIG. 2, the bottom side (A) is curved to fit comfortably over the leg of the player. The top neck of the instrument (G) provides the highest notes of the fingerboard, is regular length, and positioned like a normal neck. It uses a string nut (F) and bridge. (E) The bottom neck (H) is one half normal length. When the bridge is located on the rear face of instrument the bottom neck uses string nut, (C) and a set of string rollers. (D) Just past string nut (C) are tuning pegs for each string. FIG. 3 shows the back of the instrument when the bottom neck's bridge is located on the rear face, with bridge (B) anchoring the strings.

In another variation of the invention, the bottom neck is placed further up the body horizontally, and is either regular length or three quarter length, serving to make the lower frets closer to the body of the musician.

In FIG. 4, the bottom side (A) is curved to fit comfortably over the leg of the player. The top neck of the instrument (G) provides the highest notes of the fingerboard, is regular length, and positioned like a normal neck. It uses a string nut (F) and bridge. (E) The bottom neck (H) is approximately ¾ normal length. When the bridge is located on the rear face of instrument the bottom neck uses string nut, (C) and a set of string rollers. (D) Just past string nut (C) are tuning pegs for each string. FIG. 3 shows the back of the instrument when the bottom neck's bridge is located on the rear face, with bridge (B) anchoring the strings.

In another variation, the bridge for the bottom neck can be placed on an extension that juts out 4 to 7 inches from the edge of the instrument body.

In FIG. 5, the bottom side (A) is curved to fit comfortably over the leg of the player. The top neck of the instrument (G) provides the highest notes of the fingerboard, is regular length, and positioned like a normal neck. It uses a string nut (F) and bridge. (E) The bottom neck (H) is one half normal length, but could be three quarters normal length. The bottom neck uses string nut, (C) which guide the strings down the neck where they are anchored by a bridge (B) that is attached to an extension jutting out 4 to 7 inches from the edge of the instrument body. Just past string nut (C) are tuning pegs for each string.

In another variation, the bottom neck's bridge can be placed on the top face and near the end of the instrument body, if the body length is sufficient to provide a full scale using a short neck.

### REFERENCES CITED

[1] U.S. Patent Documents
D,183,681
Claude L. Deaver Oct. 14, 1958
[2] U.S. Patent Documents
U.S. Pat. No. 6,956,157
Russell Strobel Oct. 18, 2005
[3] U.S. Patent Documents
U.S. Pat. No. 7,705,224
Ward Apr. 27, 2010

### OTHER REFERENCES

[4] Traveler Guitar Inc: http://www.travelerguitar.com/guitars/electric/item/pro-series? category_id=4

1-14. (canceled)

15. A stringed instrument comprised of:
a body;
said body attached to a neck of regular sized length;
said neck attached near the top of the body via either glue, screws, or neck-through construction;
said neck's fingerboard which includes all the frets of the instrument's scale;
said neck attached to a headstock at the other end, with a string nut located just before a set of tuning pegs;
said neck's strings anchored by a bridge;
said bridge attached to the front face of the instrument, just past the right hand picking area of the instrument;
a one half-sized neck, located 4 inches below the top neck;
said neck attached to the body via either glue, screws, or neck-through construction;
said neck attached to a fingerboard containing the lower frets of the instrument's scale;
said neck attached to a headstock at the other end, with a string nut located just before a set of tuning pegs;
said neck attached to a set of strings;
said neck's strings attached to a set of tuning pegs at one end of the neck, and anchored by a bridge attached to the other end of the body;
said bridge attached to a strut extending out 6 inches from the edge of the instrument body, 5 inches in width, and 2 inches in height;
said stringed instrument being any of the following: an electric guitar, electric bass, acoustic guitar, acoustic bass, ukulele, mandolin, violin, cello, acoustic upright bass, or any other stringed instrument.

16. The method of claim 15, in which the distance from the body edge to the end of the extended strut is any variable length, width, and height.

17. The method of claim 15, in which the extended strut is a plate attached to the front face of the instrument by either screws or glue.

18. The method of claim 15, in which the extended strut is attached by screws and a hinge so that it can be folded over the top or bottom of the guitar, allowing for easy storage in a regular carrying case.

19. The method of claim 15 in which the headstock and tuning pegs of both necks are replaced with a locking string nut, and a set of tuners attached to the bridge.

20. The method of claim 15 in which the headstock and tuning pegs of both necks are replaced with a locking string nut and a set of tuners attached to the end of the instrument's body.

21. The method of claim 15 in which the headstock and tuning pegs of both necks are replaced with a locking string nut and a set of tuners attached to the rear face of the instrument's body.

22. The method of claim 15 in which the bridge is a movable tremolo system allowing the musician to change the pitch of notes via a tremolo bar.

23. The method of 15 in which the distance between the two necks is variable;

24. The method of 15 in which the short neck is attached to the top of the body and the regular size neck is attached to the bottom of the body.

25. The method of 15 in which the entire instrument, is made from one single piece of material;
said instrument comprised of a body, and one or more of necks;
said material being either a single piece of wood, metal, plastic, graphite, composite, or any other type of matter;
said instrument constructed by either hand carving, machine carving, or 3-D printer.

26. The method of 15 in which the bridge anchoring the strings of the shorter neck is attached near the edge of the front face of the body.

27. The method of 15 in which the bridge of the shorter neck is placed on the rear face of the instrument via a set of individual string rollers which revolve around a spindle;
said spindle attached either at the end of the body or near the end of the body through a recessed hole;
said string rollers are made of either metal or graphite.

28. The method of 15 in which the bridge of the shorter neck is placed on the rear face of the instrument via a set of individual string rollers which revolve around a spindle;
said spindle attached either at the end of the body or near the end of the body through a recessed hole;
said string rollers are made of any type of hard material.

29. The method of 15 in which the bridge of the shorter neck is placed on the rear face of the instrument via a set of individual string rollers which revolve around a spindle;
said spindle attached either at the end of the body or near the end of the body through a recessed hole;
said string rollers to contain a greased, ball bearing.

30. The method of 15 in which the bridge of the shorter neck is placed on the rear face of the instrument via a set of individual string rollers which revolve around a spindle;
said spindle attached either at the end of the body or near the end of the body through a recessed hole;
said string rollers to contain any type of ball bearing or race.

31. The method of 15 in which the shorter neck is recessed into the body so that only a portion of the neck sticks out from the edge of the body;
said neck attached to the body by either screws, glue, or neck-through construction;
said neck is of three-quarters length.

32. A guitar neck recessed into the body of a stringed instrument so that only a portion of the neck sticks out from the edge of the body;
said neck attached to the body by either screws, glue, or neck-through construction;
said neck is of any variable length.
